(19) United States
(12) Patent Application Publication
(10) Pub. No.: US 2023/0392863 A1
(43) Pub. Date: Dec. 7, 2023

(54) DRYING DEVICE AND METHOD OF DRYING AN ITEM

(71) Applicant: Vestel Elektronik Sanayi ve Ticaret A.S., Manisa (TR)

(72) Inventors: Barbaros KIRISKEN, Manisa (TR); Gozde DEGER SARI, Manisa (TR)

(21) Appl. No.: 18/034,008

(22) PCT Filed: Oct. 27, 2020
(86) PCT No.: PCT/EP2020/080159

§ 371 Date: Apr. 26, 2023

(51) Int. Cl. F26B 3/092; F26B 13/24

(52) U.S. Cl. CPC F26B 3/0923; F26B 13/24

(57) ABSTRACT

A drying device (10) for drying an item (50) has a vibration plate (20) and a charge generator (30). The vibration plate (20) is operable to vibrate to force water droplets off the item (50) when in contact with the vibration plate (20). The charge generator (30) generates an electrostatic charge on the vibration plate (20) to hold the item (50) in contact with the vibration plate (20) during operation of the vibration plate (20).

### TECHNICAL FIELD

The present disclosure relates to a drying device and a method of drying an item.

### BACKGROUND

When a wet item needs to be dried, basically two options are available. As one option, the item is simply left out in open air, possibly hanging from a line or some frame or the like, so that water in the item can evaporate away. Whilst being energy-efficient, this can be a slow process and is not always convenient or suitable. Alternatively, some machine or device is used to heat the item, thereby warming the water and therefore accelerating the evaporation of water from the item. However, this uses a lot of energy. Further, it may not always be appropriate to apply heat to an item as that may damage the item.

### SUMMARY

According to a first aspect disclosed herein, there is provided a drying device for drying an item, the drying device comprising:
a vibration plate, the vibration plate being operable to vibrate to force water droplets off an item that is in contact with the vibration plate; and
a charge generator for generating an electrostatic charge on the vibration plate;
the charge generator being operable to generate an electrostatic charge on the vibration plate to hold a said item in contact with the vibration plate during operation of the vibration plate.

Operation of the vibration plate causes the vibration plate to vibrate, which drives water droplets off an item that is in contact with the vibration plate. The electrostatic charge that is built up on the vibration plate induces an opposite charge on the item, which causes the item to be held in contact with the vibration plate. This maximises the rate of transfer of vibrational energy from the vibration plate to the item, and specifically to the water in the item, thus reducing the drying time for the item and/or minimising power consumption.

The charge generator may be for example an electrostatic generator. The electrostatic generator may be of the “influence machine” type, which uses electrostatic induction, including for example a Van de Graaff generator.

In an example, the drying device comprises one or more sensors for providing a measure of the amount of water contained in a said item, the charge generator being operable to vary the amount of electrostatic charge on the vibration plate according to the amount of water contained in a said item.

This provides for a number of advantages, including ensuring good contact between the item and the vibration plate, thus reducing the drying time for the item and/or minimising power consumption.

In an example, the charge generator is configured such that the amount of electrostatic charge generated on the vibration plate reduces as the amount of water contained in a said item reduces.

In an example, the charge generator is configured such that:
the amount of electrostatic charge generated on the vibration plate is at a zero or minimum level when the amount of water contained in a said item is above a threshold,
the amount of electrostatic charge generated on the vibration plate is at a maximum when the amount of water contained in a said item is or falls below the threshold, and
the amount of electrostatic charge generated on the vibration plate reduces from the maximum as the amount of water contained in a said item reduces further.

In an example, the drying device comprises plural sensors for providing a measure of the amount of water contained in a said item at different respective locations in a said item, the charge generator being configured such that different amounts of electrostatic charge are generated at different locations on the vibration plate corresponding to different amounts of water contained in a said item at the different respective locations in a said item.

In an example, the sensors are capacitive sensors.

In an example, the drying device comprises at least one sensor for providing a measure of the amount of water contained in a said item by measuring the weight of a said item.

In an example, the drying device comprises one or more sensors for providing a measure of the amount of water contained in a said item, the drying device being configured to drive the vibration plate such that at least one of the amplitude and the frequency of vibration of the vibration plate depends on the amount of water contained in a said item.

According to a second aspect disclosed herein, there is provided a method of drying an item, the method comprising:
applying an electrostatic charge to a vibration plate to hold an item to be dried in contact with the vibration plate; and
operating the vibration plate to vibrate to force water droplets off the item when the item is in contact with the vibration plate.

In an example, the method comprises measuring the amount of water contained in the item, and varying the amount of electrostatic charge on the vibration plate according to the amount of water contained in the item.

In an example, the method comprises reducing the amount of electrostatic charge generated on the vibration plate as the amount of water contained in the item reduces.

In an example, the method comprises varying the amount of electrostatic charge generated on the vibration plate such that:
the amount of electrostatic charge generated on the vibration plate is at a zero or minimum level when the amount of water contained in the item is above a threshold,
the amount of electrostatic charge generated on the vibration plate is at a maximum when the amount of water contained in the item is or falls below the threshold, and
the amount of electrostatic charge generated on the vibration plate reduces from the maximum as the amount of water contained in the item reduces further.

In an example, the method comprises measuring the amount of water contained in the item at different locations in the item, and generating different amounts of electrostatic charge at different locations on the vibration plate corresponding to different amounts of water contained in the item at the different respective locations in the item.

In an example, the method comprises measuring the amount of water contained in the item, and driving the vibration plate such that at least one of the amplitude and the frequency of vibration of the vibration plate depends on the amount of water contained in the item.

### BRIEF DESCRIPTION OF THE DRAWINGS

To assist understanding of the present disclosure and to show how embodiments may be put into effect, reference is made by way of example to the accompanying drawings in which:

FIG. 1 shows schematically a cross-sectional view an example of a device according to the present disclosure and an item to be dried;

FIG. 2 shows schematically a perspective view of the device of FIG. 1 and an item to be dried;

FIG. 3 shows schematically how an item to be dried can become detached from the device during operation; and

FIG. 4 shows schematically an example of variation of electrostatic charge applied to the device over time according to the wetness of the item.

### DETAILED DESCRIPTION

As stated, when a wet item needs to be dried, it is common for some machine or device to be used to heat the item, thereby warming the water and therefore accelerating the evaporation of water off the item. Such machines and devices include domestic or industrial tumble dryers for drying fabrics or other sheet materials, such as laundry items or the like, ovens or other hot chambers for drying various domestic and industrial items, etc. However, such machines and devices use a lot of energy. Further, it may not always be appropriate to apply heat to an item as that may damage the item.

According to an example of the present disclosure, a drying device for drying an item is provided. The drying device has a vibration plate. The vibration plate is operable to vibrate to force water droplets off the item that is in contact with the vibration plate. The drying device also has a charge generator for generating an electrostatic charge on the vibration plate. The charge generator is operable to generate an electrostatic charge on the vibration plate. This electrostatic charge holds the item in contact with the vibration plate during operation of the vibration plate.

The use of vibrational energy to force water off the item can reduce the energy consumption and/or the time that is required to dry the item compared to a device or machine that heats the item and the water. This also avoids having to heat the item, which therefore helps prevent heat damage being caused to the item. Holding the item against the vibration plate maximises the rate of transfer of vibrational energy from the vibration plate to the item, and specifically to the water in the item, thus reducing the drying time for the item and/or minimising energy consumption.

The vibration plate may be vibrated in conjunction with some heating of the item. However, in the main example described herein, vibration of the item is sufficient and no additional heating needs to be applied.

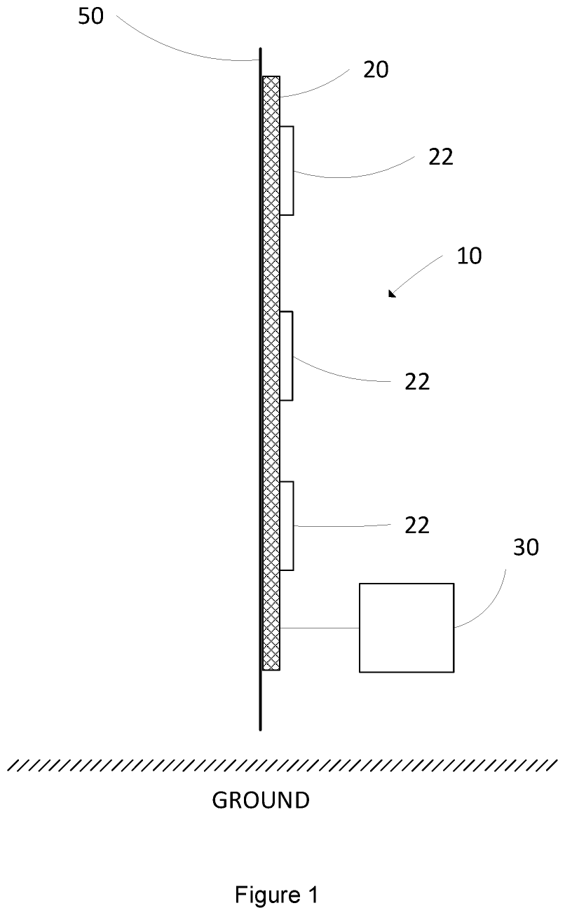

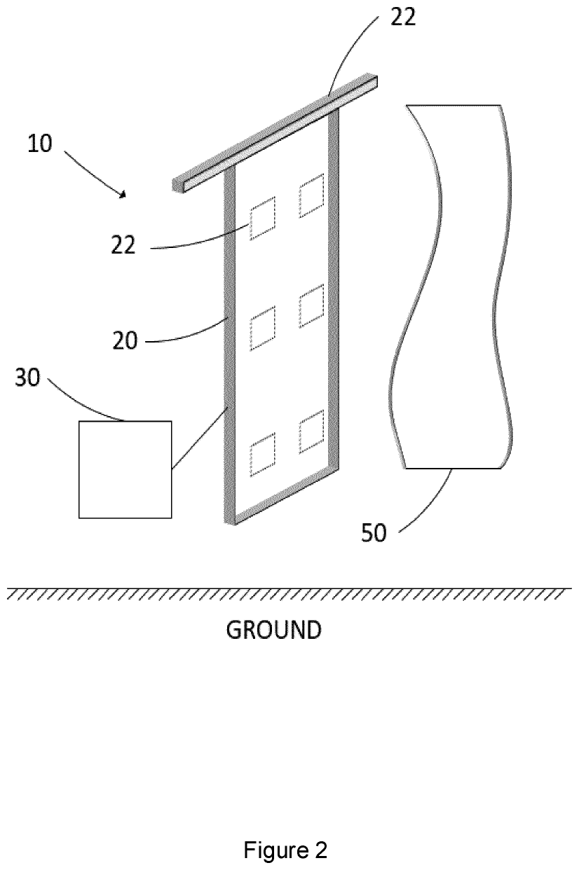

Referring now to FIGS. 1 and 2 of the drawings, there is shown an example of a device 10 according to the present disclosure. The device 10 is for drying a wet item 50. The item 50 to be dried is in general in the form of a planar sheet of material, which may be for example paper or a natural or synthetic fabric or a fabric that is a mix of natural and synthetic materials, including for example cotton, wool, acrylic, polyester, etc. The item 50 may for example be a laundry item, such as an item of clothing, bedding, etc.

The device 10 has two main components: a vibration plate 20 and a charge generator 30. Operation of the device 10 as a whole may be controlled by one or more processors (not shown), which for example receive inputs from one or more sensors and a user and controls operation of the device 10 accordingly. Alternatively, a processor as such may not be required, and instead the device 10 may operate through appropriate circuitry, again based on for example inputs from one or more sensors and a user.

The vibration plate 20 is a generally rigid, generally planar plate which is relatively long and wide and which has a relatively narrow thickness. The vibration plate 20 is electrically insulating and/or is not connected to an electrical earth or ground. This is so that a static electric charge can be built up and maintained on the vibration plate 20, as will be explained further below. The vibration plate 20 may be formed of for example a rigid plastics material, including particularly a thermoplastic material for example. Some examples include nylon, acrylic, acrylonitrile butadiene styrene (ABS), etc., and mixtures thereof. Alternatively, if the vibration plate 20 is shielded from earth in use, then a metal or mixture of metals may be used for the vibration plate 20, including for example steel, aluminium, etc.

The vibration plate 20 is caused to vibrate in use. A number of options for causing this vibration are possible. In the example shown, the vibration plate 20 has a number of vibration elements 22 arranged over its surface and/or in the body of the vibration plate 20. The vibration elements 22 are driven in use to cause the vibration plate 20 to vibrate. In examples, the vibration elements 22 are piezoelectric transducer devices. In use, a voltage from a power source (not shown, and which may for example be a mains power source, a battery power source, etc.) is applied to the piezoelectric vibration elements 22 to cause them to vibrate, which in turn causes the vibration plate 20 to vibrate. Various options for driving the vibration elements 22 will be discussed further below. As an alternative to having vibration elements 22 arranged over its surface and/or in the body of the vibration plate 20, one or more vibration elements may be fixed to a side or edge of the vibration plate 20. Other arrangements are possible. In an example, the vibration elements 22 are controlled to vibrate at ultrasonic frequencies, for example above around 20 kHz or so, which can lead to efficient drying whilst not disturbing the user.

When an item 50 to be dried is in contact with the vibration plate 20, vibration of the vibration plate 20 forces water out of and off the item 50. As part of this, vibration of the vibration plate 20 may break up the water in the item 50 into small droplets which can then evaporate away, for example in the form of a mist. In use in practice, the item 50 may be fixed at at least one end (for example, an upper end) to or near the vibration plate 20 to hold the item 50 at least approximately in place. For example, referring particularly to FIG. 2, the vibration plate 20 may be fixed at its upper end to and suspended vertically from a rail 24. In such a case, the item 50 to be dried may also be fixed to or hung over the rail 24.

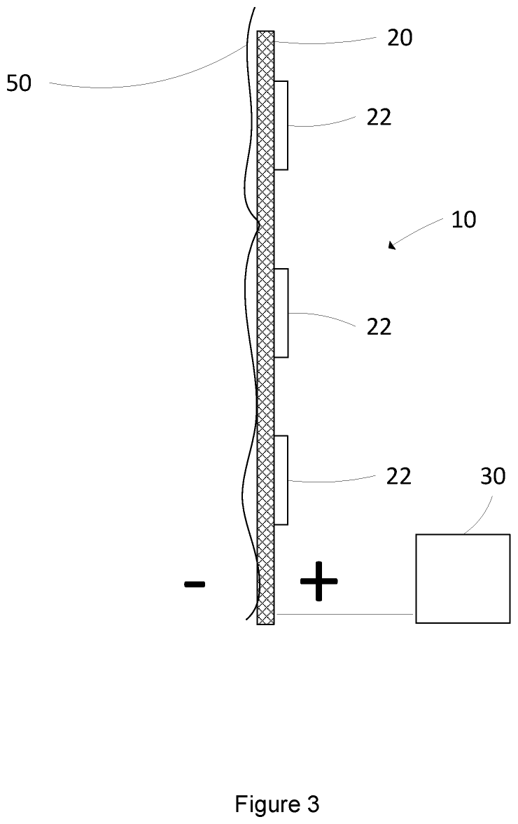

In order to ensure a good transfer of vibrational energy from the vibration plate to the item 50, and particularly to the water in the item 50, a good contact between the item 50 and the vibration plate 20 should be maintained, especially when the vibration plate 20 is being caused to vibrate. However, and referring to FIG. 3, a problem can occur in that as the vibration plate 20 vibrates, this can force the item 50 out of contact with the vibration plate 20, either as a whole or locally at one or more positions over the vibration plate 20/item 50. (For completeness, it is noted that this can occur even if the item 50 is fixed at one end or even on all sides to or near the vibration plate 20. Further, it is typically not practical or feasible to fix the item 50 over the whole of its surface to the vibration plate 20.) If the item 50 is not in good contact with the vibration plate 20, vibrational energy cannot be transferred effectively to the item 50 or is only transferred intermittently and/or at certain locations. This can increase the time and/or energy that is required for the item 50 to be dried.

To address this, the device 10 of the present disclosure has a charge generator which is electrically connected to the vibration plate 20. The charge generator 30 is connected in turn to a power source (not shown, and which again may for example be a mains power source, a battery power source, etc.). The charge generator 30 is operated to generate a static electric charge which is applied to the vibration plate 20. The static charge on the vibration plate 20 attracts the item 50 to the vibration plate 20, and holds the item 50 against the vibration plate 20, by inducing an opposite electric charge in the item 50. This ensures a good contact between the item 50 and the vibration plate 20 and therefore an effective transfer of vibrational energy to the water in the item 50, thus making the drying process more efficient. This means that less energy is consumed in driving the vibration of the vibration plate 20 and/or that the time required to dry the item 50 is reduced.

The charge generator 30 may be for example an electrostatic generator. The electrostatic generator may for example be of the “influence machine” type, which uses electrostatic induction. A well known example of an electrostatic generator of the influence machine type is the Van de Graaff generator.

A number of options for applying the static charge to the vibration plate 20 are possible. As a simple example, static charge may always be applied when an item 50 is present. In another example, which is more energy-efficient, static charge may be applied only during operation of the device 10, that is, when the vibration plate 20 is being caused to vibrate.

However, it has been appreciated that further energy savings can be made. In particular, it is noted first that when the item 50 is very wet, the item 50 will tend to stick to the vibration plate 20 in any event. Therefore, when the item 50 is very wet, it may not be necessary for a static charge to be applied to the vibration plate 20. It is also noted that when the item 50 is very wet, the water will tend to discharge any static electricity on the vibration plate 20, and so applying a static charge at that time is likely not to be very effective in any event.

However, once the wetness of the item 50 decreases, and is for example below some threshold, then it may become necessary for a static charge to be applied to the vibration plate 20 in order to maintain a good contact between the item 50 and the vibration plate 20. It is noted however that because of the high level of water content in the item 50 at this point, there will typically still be a tendency for static charge on the vibration plate 20 to be discharged by the wet item 50. Therefore, a high level of static charge should be applied initially. Over time however, as water is driven off the item 50 by vibration of the vibration plate 50, the tendency for the static charge to be discharged by the wet item 50 will reduce, and therefore the amount of static charge that is applied can be reduced.

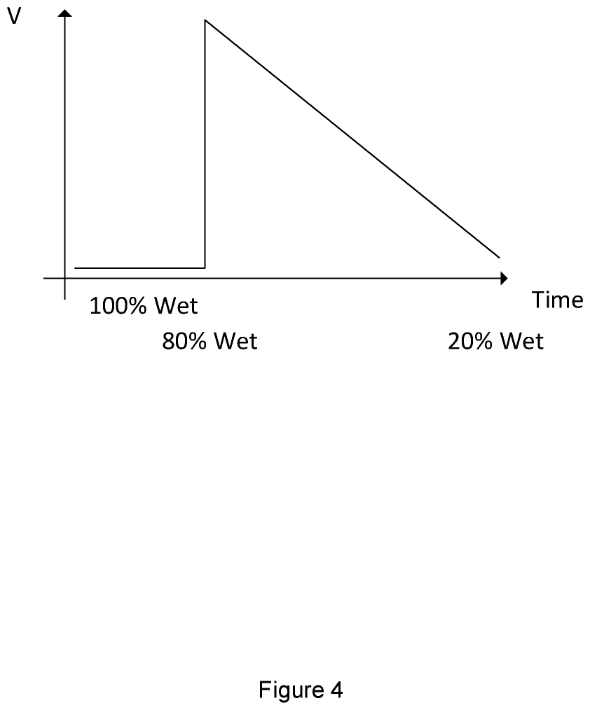

This is illustrated schematically in FIG. 4, which shows an example of variation of electrostatic charge applied to the vibration plate 20 over time according to the wetness of the item 50. Initially, when the item is very wet (mentioned schematically as “100% wet”), no electrostatic charge is applied to the vibration plate Operation of the vibration plate 20 will drive water off the item 50, causing the wetness of the item 50 to fall over time. Once the wetness of the item 50 is below some threshold (mentioned schematically as “80% wet”), or if the wetness of the item was already below that threshold when the item 50 was first attached to the device then a maximum level of electrostatic charge is applied to the vibration plate 20. Further operation of the vibration plate 20 will drive more water off the item 50, causing the wetness of the item 50 to fall further. The level of electrostatic charge applied to the vibration plate 20 can be correspondingly reduced.

The amount of electrostatic charge applied to the vibration plate 20 can be varied by changing one or both of the frequency of the application of the electrostatic charge and the voltage (i.e. total amount) of the electrostatic charge that is applied.

Various options for measuring the wetness of the item 50 are possible. In this regard, it is noted that the wetness of the item 50, that is, the amount of water present in the item 50, does not need to be measured precisely or with great accuracy. This is because all that is needed is some at least approximate measure of the amount of water so that an appropriate amount of electrostatic charge can be generated and applied to the vibration plate 20 as and when necessary.

As one example, a weight sensor may be used to provide a measure of the total weight of the item 50. The item 50 may for example be suspended from a weight sensor in the device 10. As the weight of the item 50 falls, it is assumed that this is because water is being driven off the wet item 50 by the vibration plate. Therefore, as the wetness of the item 50 falls and the weight falls, the level of electrostatic charge can be varied as described above. Further, in an example, a “base” or “reference” weight for the item 50 may be used as part of this. The “base” or “reference” weight for the item 50 may be a dry weight of the item 50, that is, when the item 50 is dry and contains no water. For example, a base” or “reference” weight for the item 50 may be either entered manually by the user for recordal by the device 10, or the item 50 may be weighed (using for example the weight sensor) before being washed and that dry weight recorded by the device 10. This “base” or “reference” weight for the item 50 may then be used by the device 10 to allow the device 10 to discriminate between on the one hand for example an item 50 that is lightweight when dry but contains a lot of water and on the other hand an item 150 that is heavy when dry and that contains less water.

As another example, a capacitive sensor may be used to provide a measure of the amount of water in the item 50. A capacitive sensor effectively provides a measure of the dielectric or relative permittivity of the item 50, which is strongly correlated with or determined by the amount of water in the item 50. As the relative permittivity of the item 50 falls, it is assumed that this is because water is being driven off the wet item 50 by the vibration plate 20. Therefore, as the relative permittivity of the item 50 falls, the level of electrostatic charge can be varied as described above. If a capacitive sensor is used to obtain a measure of the wetness of the item 50, the capacitive sensor is located so as to contact the item 50 when the item 50 is in place near to or touching vibration plate 20.

Further, plural capacitive sensors may be provided to obtain measurements of the wetness of the item 50 at a number of different locations. In such a case, different amounts of static charge can be applied to the vibration plate 20 at different locations corresponding to the different locations on the item 50 where the amount of water has been measured. For example, if a particular capacitive sensor indicates that a particular location of the item 50 is relatively dry, a small amount of static charge can be applied to the vibration plate 20 at or near that location. Conversely, if a particular capacitive sensor indicates that a particular location of the item 50 is relatively wet, a large amount of static charge can be applied to the vibration plate 20 at or near that location. The charge generator 30 may have plural electrical connections to the vibration plate 20 so as to be able to provide different amounts of charge to the plate at the different locations.

In a further variation, the vibration plate 20 may be driven to vibrate according to the wetness of the item 50. For example, initially, when the item is very wet, the vibration plate 20 may be driven to vibrate with a high frequency and/or high amplitude. As the item 50 dries, the frequency and/or amplitude of vibration of the vibration plate 20 may be correspondingly reduced.

Further, if there are plural vibration elements 22 arranged over the surface and/or in the body of the vibration plate 20 and there are vibration elements 22, then the different vibration elements 22 can be driven differently according to the local wetness of the item 50 at different locations. For example, if there are plural (capacitive) sensors for providing local measurements of the wetness of the item 50, and if a particular sensor indicates that a particular location of the item 50 is relatively dry, the corresponding vibration element(s) 22 at or near that location may only be powered with a low frequency and/or low amplitude. Conversely, if a particular sensor indicates that a particular location of the item 50 is relatively wet, the corresponding vibration element(s) 22 at or near that location may be powered with a high frequency and/or high amplitude.

As a practical matter, the level of electrostatic charge applied to the vibration plate 20 may be relatively low, such that the voltage does not present a hazard to users.

Finally, again as a practical matter, it may be useful to arrange for any static charge to be discharged to earth once the item 50 has been dried, again to avoid any hazard to the user. For example, a mechanical arm or contact or the like may be automatically moved to contact the item 50 and/or the vibration plate 20 at the end of the drying process to earth the item 50 and/or the vibration plate 20.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The examples described herein are to be understood as illustrative examples of embodiments of the invention. Further embodiments and examples are envisaged.

Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A drying device for drying an item, the drying device comprising:
a vibration plate, the vibration plate being operable to vibrate to force water droplets off an item that is in contact with the vibration plate; and
a charge generator for generating an electrostatic charge on the vibration plate;
the charge generator being operable to generate an electrostatic charge on the vibration plate to hold a said item in contact with the vibration plate during operation of the vibration plate.

2. A drying device according to claim 1, comprising one or more sensors for providing a measure of the amount of water contained in a said item, the charge generator being operable to vary the amount of electrostatic charge on the vibration plate according to the amount of water contained in a said item.

3. A drying device according to claim 2, wherein the charge generator is configured such that the amount of electrostatic charge generated on the vibration plate reduces as the amount of water contained in a said item reduces.

4. A drying device according to claim 2, wherein the charge generator is configured such that:
the amount of electrostatic charge generated on the vibration plate is at a zero or minimum level when the amount of water contained in a said item is above a threshold,
the amount of electrostatic charge generated on the vibration plate is at a maximum when the amount of water contained in a said item is or falls below the threshold, and
the amount of electrostatic charge generated on the vibration plate reduces from the maximum as the amount of water contained in a said item reduces further.

5. A drying device according to claim 2, comprising plural sensors for providing a measure of the amount of water contained in a said item at different respective locations in a said item, the charge generator being configured such that different amounts of electrostatic charge are generated at different locations on the vibration plate corresponding to different amounts of water contained in a said item at the different respective locations in a said item.

6. A drying device according to claim 5, wherein the sensors are capacitive sensors.

7. A drying device according to claim 2, comprising at least one sensor for providing a measure of the amount of water contained in a said item by measuring the weight of a said item.

8. A drying device according to claim 1, comprising one or more sensors for providing a measure of the amount of water contained in a said item, the drying device being configured to drive the vibration plate such that at least one of the amplitude and the frequency of vibration of the vibration plate depends on the amount of water contained in a said item.

9. A method of drying an item, the method comprising:
applying an electrostatic charge to a vibration plate to hold an item to be dried in contact with the vibration plate; and
operating the vibration plate to vibrate to force water droplets off the item when the item is in contact with the vibration plate.

10. A method according to claim 9, comprising measuring the amount of water contained in the item, and varying the amount of electrostatic charge on the vibration plate according to the amount of water contained in the item.

11. A method according to claim 10, comprising reducing the amount of electrostatic charge generated on the vibration plate as the amount of water contained in the item reduces.

12. A method according to claim 10, comprising varying the amount of electrostatic charge generated on the vibration plate such that:
the amount of electrostatic charge generated on the vibration plate is at a zero or minimum level when the amount of water contained in the item is above a threshold,
the amount of electrostatic charge generated on the vibration plate is at a maximum when the amount of water contained in the item is or falls below the threshold, and
the amount of electrostatic charge generated on the vibration plate reduces from the maximum as the amount of water contained in the item reduces further.

13. A method according to claim 10, comprising measuring the amount of water contained in the item at different locations in the item, and generating different amounts of electrostatic charge at different locations on the vibration plate corresponding to different amounts of water contained in the item at the different respective locations in the item.

14. A method according to claim 9, measuring the amount of water contained in the item, and driving the vibration plate such that at least one of the amplitude and the frequency of vibration of the vibration plate depends on the amount of water contained in the item.
